(19) United States
(12) Patent Application Publication
(10) Pub. No.: US 2017/0024491 A1
(43) Pub. Date: Jan. 26, 2017

(54) DESIGN AND FABRICATION OF COMPOSITE MATERIAL COMPONENTS

(71) Applicant: GKN Aerospace Services Limited, Hampshire (GB)

(72) Inventor: Timothy James Dodwell, Bath (GB)

(21) Appl. No.: 15/124,745

(22) PCT Filed: Mar. 6, 2015
(86) PCT No.: PCT/GB2015/050652

§ 371 Date: Sep. 9, 2016

(30) Foreign Application Priority Data
Mar. 10, 2014 (GB) 1404184.2

(51) Int. Cl. G06F 17/50

(52) U.S. Cl. CPC G06F 17/50; G06F 2217/44; G06F 2217/12

(57) ABSTRACT

A composite component can be designed for manufacture using a pre-impregnated uni-directional or woven material A design for a composite component comprising multiple layers of pre-impregnated uni-directional or woven material is created. Within the design a division of the design into a plurality of macroscale elements is defined. For each macroscale element, a microscale relative volume element is defined, model parameters for the microscale relative volume element are determined, and the microscale relative volume element is upscaled to provide a set of model parameters describing the macroscale element. The set of model parameters for each macroscale element is used to analyse the design to identify the presence or absence of regions where structures likely to be detrimental to the integrity of the component would be expected to occur when manufacturing a component according to the design. If regions where structures likely to be detrimental to the integrity of the component would be expected to occur are identified, data describing these regions is outputted to a redesign process.

### CROSS-REFERENCE TO RELATED APPLICATIONS

This application is a national stage of, and claims priority to, Patent Cooperation Treaty Application No. PCT/GB2015/050652, filed on Mar. 6, 2015, which claims priority to Great Britain Application No. GB1404184.2 filed on Mar. 10, 2014, each of which applications are hereby incorporated herein by reference in their entireties.

### BACKGROUND

In the field of composite material components, it is known to produce components for vehicles, including aircraft, from composite materials, such as multi-layer fibre-reinforced resins and the like. It is also known that some elements manufactured from composite materials may experience localised stresses in or between the layers of fibre reinforcement.

### SUMMARY

The present application relates to methods and systems for design and fabrication of composite material components and in particular, but not exclusively, to methods and systems that operate to identify potential problem areas and revise the design of those areas prior to fabrication.

Particular and preferred aspects are set forth in the appended claims.

Viewed from a first aspect, the present teachings relate to a method of designing a composite component for manufacture using a pre-impregnated uni-directional or woven material; the method comprising: creating a design for a composite component comprising multiple layers of pre-impregnated uni-directional or woven material; defining within the design a division of the design into a plurality of macroscale elements; for each macroscale element, defining a microscale relative volume element, determining model parameters for the microscale relative volume element, and upscaling the microscale relative volume element to provide a set of model parameters describing the macroscale element; using the set of model parameters for each macroscale element to analyse the design to identify the presence or absence of regions where structures likely to be detrimental to the integrity of the component would be expected to occur when manufacturing a component according to the design; if regions where structures likely to be detrimental to the integrity of the component would be expected to occur are identified, making data describing these regions available to a redesign process. Thereby and efficient process of design for manufacture can be carried out, thereby reducing the amount of time manufacturing candidate designs for testing before a design can be approved for manufacture.

Viewed from another aspect, the present teachings relate to a method of manufacturing a composite component, the method comprising: designing a composite component according to the approach of the present teachings; and manufacturing the component using pre-impregnated uni-directional or woven material.

Viewed from a further aspect, the present teachings relate to a computer program product comprising processor implementable instructions for causing a programmable computer to carry out the method according to the present disclosure.

### BRIEF DESCRIPTION OF THE FIGURES

Examples in accordance with the present teachings will now be set forth by reference to the accompanying drawings, in which:

FIGS. 1A and 1B illustrates schematically how imperfections can arise in a multi-layer structure when subjected to debulking;

FIG. 2 is a micrograph image illustrating wrinkles in a multi-layer structure of the type illustrates schematically in FIG. 1;

FIG. 3 is a schematic representation of a part of a multilayer structure showing macro- and micro-elements defined therein;

FIG. 4 illustrates a comparison between higher order continuum modelling and standard finite element analysis modelling;

FIGS. 5A and 5B illustrate examples of higher order continuum modelling of radius consolidation internal buckling situations; and

FIG. 6 illustrates steps in an iterative design process.

While the presently described approach is susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope as defined by the appended claims

### DETAILED DESCRIPTION

The present teachings relate to design of composite components in which the design process includes steps that can identify likely areas for wrinkling to occur when fabricating a composite component according to the design. Such wrinkles can occur in various layers of a multi-layer uni-directional material used to form a composite component. In some composite manufacturing techniques, layers of uni-directional or woven material that will form reinforcing fibres in the completed component are laid up on or in a mould to create the shape of the component. Next a debulking process is carried out to press the layers together tightly in the mould. The layers of material may be pre-impregnated with a resin that is then caused to flow between the layers to create resin bonds therebetween and then cure by applying heat and/or pressure to the layers after debulking. Thus a composite component is made from fibre-reinforced resin and having multiple layers of fibre-reinforcement material in the component.

It has been identified that when fabricating components according to the above method, that individual ones of the layers can be deformed or distorted in some way as part of the lay-up and debulking processes. These distortions can include wrinkles or buckling in ones of the layers as the layers are pressed down into the mould as part of the debulking process. It will be appreciated that having wrinkling or buckling in the layers of a component fabricated from pre-impregnated uni-directional material is likely to compromise the structural integrity of the component, leading to an inherent weakness in the component in the region of the wrinkles and thus a manufactured component would likely need to be discarded, if the defect is noticed during quality assurance and testing. Accordingly, a component design may need to be made much thicker and heavier in order to reliably achieve a required strength during manufacture.

These principles of manufacturing difficulty with respect to wrinkling and buckling are illustrative examples of a wider contemplation of manufacturing defects. Thus although a modelling process as described herein is applicable to determining wrinkling issues in a composite component, other internal structure characteristics can also be understood from the modelling result, for example uneven fibre volume or porosity.

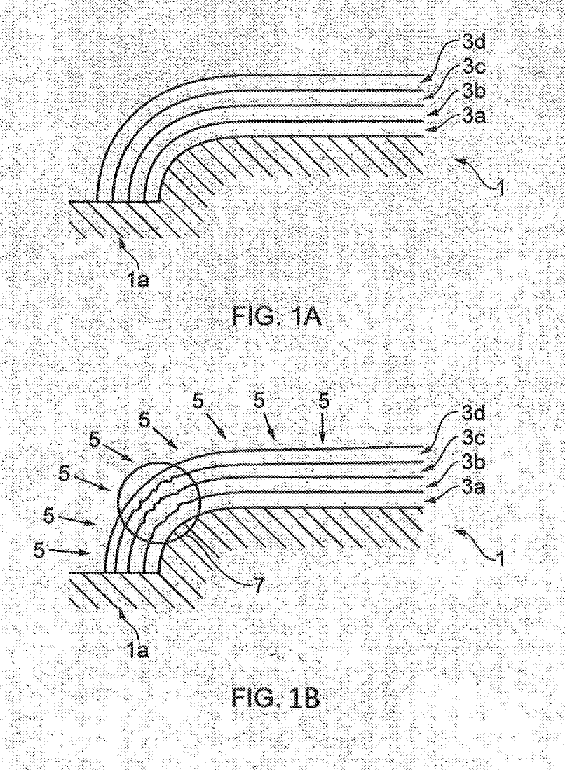

FIG. 1 illustrates in schematic terms how a debulking process could cause wrinkles to form in individual ones of the layers of a multi-layer composite component during manufacture. This figure illustrates the specific example of wrinkling around a corner radius, although it will be appreciated that a variety of component shapes and configurations could lead to wrinkling. FIG. 1A shows a mould 1 onto which four layers 3a, 3, 3c, 3d of pre-impregnated uni-directional material have been placed. FIG. 1B then illustrates the application of pressure for debulking in the form of arrows 5 that indicate an applied force. As can be seen in region 7, the layers 3a, 3b, 3c all suffer from some level of wrinkling as the layers are pressed closer together and closer to the mould such that the same amount of layer material has to fit into a smaller volume. As can be seen, the layer material is unable to move away from the region 7 due to the stop end 1a that forms a part of the mould near the region 7.

It will be appreciated that such wrinkling can be reduced by designing component curves and radii and choosing materials and processes of a composite element to allow space for the layers to move relative to one another during debulking. Such an approach thus allows the excess material that could form a wrinkle to move relative to the other layers so as to move away from the region in which less material is required after debulking than before debulking. Such moved material may be accommodated in other parts of the component without causing wrinkling.

Thus it can be seen that to be able to identify areas in a design where wrinkling may occur during a design stage before fabrication could have utility in the manufacture of composite components. The reader will appreciate that advantages of composite laminates are often compromised by high costs, long development time, and poor quality due to multiple defects, particularly in massive complex parts such as those found in aerospace applications. Thus an approach that can reduce the likelihood of manufacturing defects and reduce the amount of time required to repeated manufacture of test elements for testing prior to finalising a design for production manufacture may have widespread application in the composites industry.

However, it has also been established that to model the behaviour of even a simple composite component consisting of a small number of layers using conventional modelling approaches, such as finite element analysis, to capture the deformation of each layer require, even in these times of inexpensive and powerful computers, an excessive amount of computing power and time. To model a complex component such as may be required for an aircraft using such conventional techniques would take years of processing time, even with an extremely large resource of modern computer processors.

The present teachings however include an approach for modelling and subsequent analysis of a composite component design that significantly reduces the number of computations required and hence brings the analysis of a design for wrinkle problems into the realms of realistic possibility. This approach is described in more detail hereinunder.

The approach taken in developing the presently described techniques uses a higher order continuum method to model the behaviour of component in order to identify from a component design the likelihood for wrinkling to cause problems in manufacture and thus facilitate a redesign of the component if necessary.

Classical continuum methods can be used for modelling of stresses in complex structures and are operated by dividing the complex structures into representative volume elements. Such methods require the characteristic length scale of variations in the stress field (the distribution of stress of the state of stress in a component) to be much greater than the size of representative volume element “RVE” of that material. For such cases the stress, as in bending of an isotropic material, stresses may be considered uniform over the RVE.

In both cured and to a greater extend in uncured carbon fibre laminates, the relative weakness of the interface between layers gives plies the freedom to deform and bend independently. As a result when such a material is subjected to bending, the stress varies rapidly over a length scale proportional to the layer thickness. If the method is applied such that the size of the RVE is much greater than the layer thickness, the assumption that the stress field is uniform over the RVE is violated. For such cases higher order terms in the asymptotic expansions of the stresses, about a material point, become important. Variations in stresses over an element introduce internal bending moments at the loss of symmetry of the shear stresses. Continuum descriptions of such materials, at a scale greater than the layering, require the introduction of moment stresses (bending moments per unit area). The inclusion of higher order terms in the expansion of stress leads to a generalised higher order continuum.

Of the various higher order continuum or strain gradient continuum methods available (see G. Maugin and A. Metrikine (Eds.) Mechanics of Generalized Continua: One Hundred Years After the Cosserats, Springer, 2010), one example of a method suitable for modelling of composite components is the Cosserat continuum. A detailed discussion of the application of Cosserat continuum modelling to composite component design follows hereunder.

Cosserat continuums, introduced by the Cosserat brothers (see E. Cosserat and F. Cosserat. Theorie des corps deformables. Hermann, Paris, 1909) provides a natural framework where the macro-scale (average) description of a layered material can be derived. The effective large-scale material properties encapsulate both mechanical constitutive behaviour and the geometric heterogenities on the layer scale. As a result, such continuum models have no overt layer descriptions, but interfaces are assumed smeared across the laminate. Cosserat continuum models introduce independent rotational degrees of freedom at each material point, which allows the inclusion of bending moments per unit area or coupled stresses. Such continuum models have been developed to model a diverse array of physical systems, which exhibit a discrete nature at some intermediate length scale. These have included granular media (see R. De Borst Simulation of strain localization: a reappraisal of the Cosserat Continuum 1991), masonry structures (see I. Stefanou and J. Sulem Three-dimensional Cosserat homogenization of masonry structures:elasticity, 2008) and layered rock masses in geology (see C. Dai et al. Finite Element Analysis of Cosserat Theory for Layered Rock Masses 1993 and D. Adhikary and A. Dyskin A Cosserat Continuum Model for Layered Material, 1999).

In the presently discussed approach, techniques are applied for the development and application of a higher order continuum model for process modelling of uncured carbon fibres. In some examples, the presently disclosed techniques can provide the possibility of capturing the formation of small-scale defects in large aerospace structures, at a fraction of the computational cost of conventional methods. Such efficient modelling capabilities can provide the possibility of performing an iterative loop of analysis, in which input parameters such as material, component geometry and manufacturing conditions can be optimized to improve quality, efficiency and reliability of the manufacturing process.

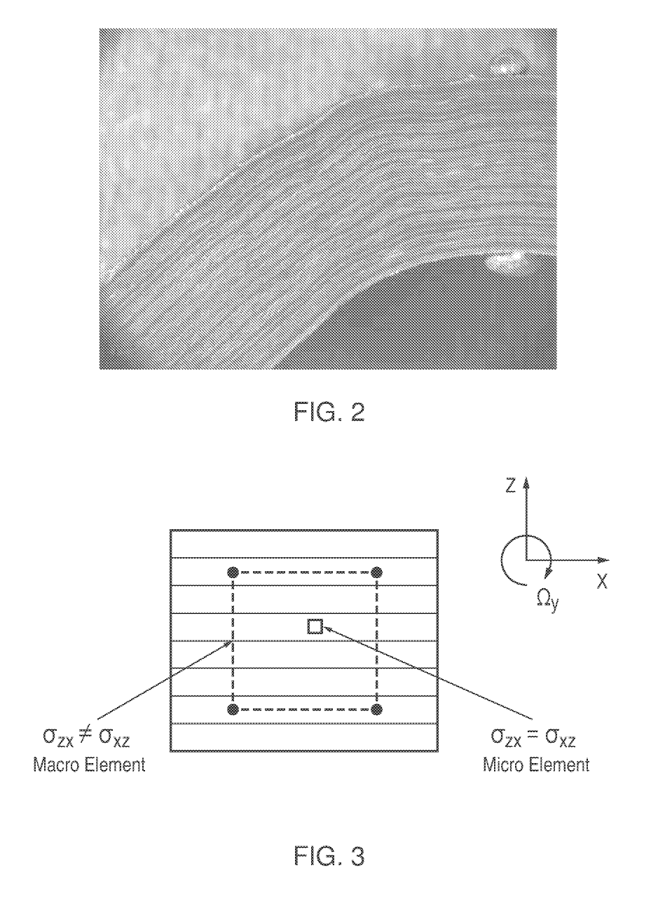

As illustrated in FIG. 2, a layered structure can suffer wrinkling during manufacture. The micrograph image of FIG. 2 generally corresponds to the conceptual illustration of wrinkling shown in FIG. 1.

The anisotropy introduced by the layering means the macroscale elements are non-symmetric (as illustrated in FIG. 3 with reference to the stress parameters α. As a result, the computation for the model involves solving equilibrium equations for both conventional and moment stresses.

$$\frac{\partial {σ}_{xx}}{\partial x} + \frac{\partial {σ}_{zx}}{\partial z} + {f}_{x} = 0 , \frac{\partial {σ}_{xz}}{\partial x} + \frac{\partial {σ}_{zz}}{\partial z} + {f}_{z} = 0 and \frac{\partial {μ}_{xy}}{\partial x} + {σ}_{xz} - {σ}_{zx} + {m}_{y} = 0. \qquad ( 1 )$$

Where σₓₓ, σ_{zz}, σ_{xz}, and σ_{zx} are conventional stresses, μ_{yx} is the moment stress and fₓ, f_{z} and m_{y} are forces and internal moment respectively. These values are all averaged over the RVE (micro-element). This defines a Cosserat continuum representation of a layered material, whereby macroscale elements retain rotational degrees of freedom, Ω_{y}.

As noted above, the present disclosure uses a definition of the macroscopic behaviour of a layered material by an equivalent continuum response. The approach of the present techniques thereby maintains the behaviour of layered structure without need to explicitly define the layers at a fine scale. This is achieved by introducing elements much greater than the layer thickness. As shown in FIG. 3, a macro-element captures the average response of the all microscale elements within an RVE. Thus a macro-scale model can be derived from upscaling the microscale elements, limiting the number of degrees of freedom in the model, and consequently reducing the computational expense of the model. This homogenisation procedure can be summarised as follows. The macro and microscale descriptions are connected by the design of specific ‘mathematical operators’ adapted from methods introduced by Forest and Sab (see S. Forest and K. Sab Cosserat Overall Modeling of Heterogeneous Materials, 1998), the use of generalised eigenproblems which compute the relevant microscale modes which are to be captured on the macroscale (see N. Spillane et al. Abstract Robust Coarse Spaces for Systems of PDEs via Generalised Eigenproblems in the Overlaps, 2011) and an application Hill-Mandel criterion, generalised for a Cosserat Continuum, to ensure consistent strain energies across scales (see Mandel, J. Plasticite Classique et Viscoplasticite, CISM Lecture Notes, Udine, Italy, Springer-Verlag,1971 and R. Hill A self-consistent mechanics of composite materials. J. Mech. Phys. Solids, 1965 for the original criteria). The resulting Cosserat material properties for a uncured composite material, derived using this method, can be combined within a finite element formulation of equation (1), for which solutions can be obtained using any standard finite element solver.

In the application of these methods to composite component design, initially all layers and interfaces have been assumed identical and elastic, and the deformation and curvature measures can be assumed infinitesimal, following plane strain assumptions. These assumptions can be generalised to capture more general material models (viscous flow, friction and plasticity for example) and other processes such as cure kinetics and temperature distributions.

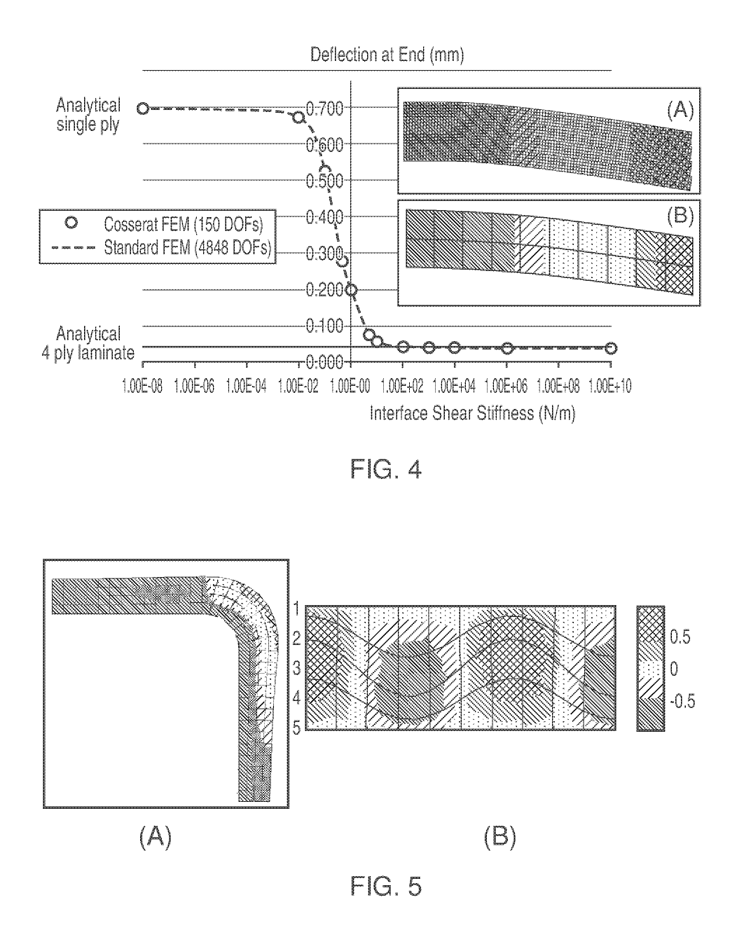

An example of the computational benefit derived from applying a higher-order continuum model, such as a Cosserat continuum model, will now be considered. This example employs a comparison between Cosserat continuum finite element analysis against a standard finite element analysis of a simple cantilever test for a multi-layered beam. The multi-layered beam used in the analysis consists of four isotropic elastic layers separated by a thin interface of shear stiffness k. The beam is clamped at one end and a transverse shear is applied to the face at the unclamped end. Solutions for increasing interlayer shear stiffness are calculated using Cosserat finite elements and standard finite elements, for which each layer and interface is modelled explicitly. FIG. 4 shows a plot of deflection of the right hand end against interlayer shear stiffness, for a multi-layered cantilever beam solved with standard finite element (A) and Cosserat finite elements (B). The analysis shown in FIG. 4 was prepared by adding the capability to calculate Cosserat finite elements in a commercially available finite element analysis tool named Abaqus™. Further examples of commercial packages to which such functionality could be added are discussed below.

It will be seen from FIG. 4 that the Cosserat finite elements give the same results as standard finite elements but requires significantly fewer elements requiring computational effort, of the order of 30 times fewer degrees of freedom (DOFs). Since computational time will scale, at best, with the square of the DOFs, the Cosserat finite elements provide for a calculation time approximately 900 times faster than conventional finite elements. For much larger calculations as seen in composite component design and manufacture applications, this difference is expected to diverge rapidly, with Cosserat finite elements showing even greater computational benefits over standard elements.

Further analyses conducted based upon the Cosserat finite element functionality produced in order to provide the comparison shown in FIG. 4 have been conducted for more structures and loading scenarios. For example, FIG. 5A shows an analysis of consolidation over a corner radius the lighter regions show areas in which in which layers of material are forced to shear over one other, a zone in which wrinkles are likely to form. In another example, FIG. 5B illustrates analysis to calculate internal wrinkle/buckling modes, with dark regions illustrating areas of greater vertical displacement. The Example in FIG. 5B shows an example where a rectangular block of material has been squashed on the right and left hand sides, while being constrained top and bottom. In each example, the finite elements, outlined by black boundaries, represent 8-10 layers, to make the physical changes more visible.

Thus comprehensive feedback can be presented to a designer while designing a composite component based upon efficient and time-effective analysis. Accordingly an iterative feedback process can be employed to provide a design for manufacture on a realistic timescale that moves at least a worthwhile part of defect testing of test-manufactured elements from to the design process.

The present disclosure outlines the application of a Multiscale Cosserat continuum framework to model the formation of wrinkling during consolidation of a laminate over a corner radii, a measure of the extent of wrinkling and thus a measure of the extent of defect likely to occur during manufacture is achieved. It is envisaged that this method can be used as part of an efficient iterative design procedure to minimise the possibility of wrinkles and other manufacturing induced defects. An outline of a possible design procedure is now described.

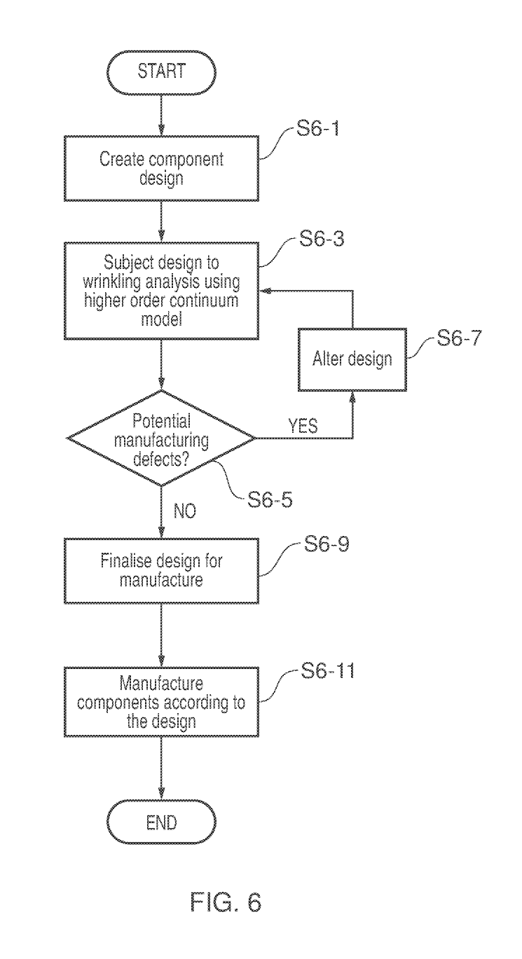

FIG. 6 shows an example of an iterative design approach for a composite component using Cosserat analysis to iteratively improve the design for a composite component that once manufactured will be made up of multiple layers of pre-impregnated uni-directional material. The process optionally includes manufacture of one or more components according to the design. In the example steps, the analysis used to inform the iterative process is concerned with the potential for defects caused by wrinkling in the layers of the component during manufacture. However the analysis may also be used to inform the design process in terms of other characteristics such as eventual bulk of the component in one or more parts of the component (for example where the dimensional envelope for the design requires certain parts of the design to provide an component that will fit between other elements of an assembled device or apparatus) and a predicted final fitness after cure for the component. These additional considerations may be used as well as or instead of the concern over wrinkling to inform the iterative process.

As illustrated in FIG. 6, a component design is produced at step S6-1 before being subjected to wrinkling analysis based upon a higher order continuum model at step S6-3. Although not illustrated, other analyses may be performed on the model with respect to, for example, projected weight, projected strength etc and these analyses may be conducted in parallel or in series with the wrinkling analysis of step S6-3.

The results of the analysis from step S6-3 are then used to determine whether the design is likely to lead to wrinkling problems that would cause manufacturing defects. Thus at step S6-5, a test is performed to check whether the analysis results indicate potential manufacturing defects severe enough to cause the component design to be considered unacceptable. The threshold for likelihood of manufacturing defects can be set based upon the nature of the component and its intended use.

If the test at step S6-5 determines that potential defects are severe enough to consider the design unacceptable, then at step S6-7 the design is altered. The aim of the design alteration is to reduce the likelihood of wrinkling occurring during a manufacture in accordance with the design, without compromising the other key criteria for the design, which may include a dimensional envelope, strength requirements, etc. After the design alteration at step S6-7, the altered design is re-subjected to wrinkling analysis based upon the higher order continuum model at step S6-3.

Once the design has achieved a high enough level of manufacturability as against the test of wrinkling analysis, then the check at step S6-5 will allow the design to proceed to step S6-9 where the design is finalised for manufacture. This step may include a number of additional sub-steps, including outputting the design to a format that can be used in manufacture, but may also include the likes of design additions for post-cure surface finishing and minimum requirements for post-manufacture testing. This step may also or alternatively include defining post-manufacture testing parameters determined from the modelling in relation to demonstrating a final fitness after cure.

After the design has been finalised for manufacture at step S6-9, a component can be manufactured to the design at step S6-11. Manufacturing a component according to the design is an optional step and may be carried out separately to the design process. This separation may be physical (for example that the manufacture takes place at a location physically removed from the design location), temporal (for example that the manufacture takes place at a time long removed from the time of finalising the design) and/or fiscal (for example that the entity responsible for the manufacture is different to the entity that produced the design).

Thus it will be understood that the design of a composite component can be iteratively revised to reduce or eliminate design elements judged by way of modelling using a Cosserat continuum model to give rise to a likelihood of manufacturing defect.

As will be appreciated, the design of a composite component is typically performed using a software tool. There are many such tools available, for example Examples of well-known software tools for production of composite component designs include Abaqus™ produced by Dassault Systèmes Simulia Corp, ANSYS™ produced by ANSYS, Inc. and the Escript tool developed by the University of Queensland. The techniques of the present disclosure relating to optimisation of a design by way of using a Cosserat continuum model to analyse a design for a composite component that once manufactured will be made up of multiple layers of pre-impregnated uni-directional material can be used alongside or incorporated within such a software design tool.

In one example, the analysis can be provided by way of a so-called plugin module to the software design tool. On another example, the analysis can be conducted upon a design exported from the design tool by the analysis engine configured as a separate package. Whether a plugin or a separate software package, the analysis may be configured to analyse a design from the design tool and to provide an output highlighting areas of the design likely to cause manufacturing defect. In one example, the output from the analysis module could provide a visual indication overlaid to a view of the model showing areas of wrinkling that would be expected and the extent of that wrinkling. In some examples a colour-code system could show the extent of wrinkling expected. The output from the analysis module can then be used as an input to refine the design if need be, as discussed above.

Therefore, there has now been described an approach for efficiently and effectively analysing a composite element design to identify potential manufacturing defects before carrying out a step of manufacture. Thereby the design can be revised and re-analysed as many times as required to reach an acceptable design for manufacture. Once the design has been optimised in this way, manufacture can be carried out.

1.-30. (canceled)

31. A method of designing a composite component for manufacture using a pre-impregnated uni-directional or woven material; the method comprising:
(i) creating a design for a composite component comprising multiple layers of pre-impregnated uni-directional or woven material;
(ii) defining within the design a division of the design into a plurality of macroscale elements, where each macroscale element is larger than the thickness of an individual layer of material in the design;
(iii) for each macroscale element, defining a microscale representative volume element, determining model parameters for the microscale representative volume element, and upscaling the microscale representative volume element to provide a set of model parameters describing the macro scale element;
(iv) identifying within the design, using the set of model parameters for each macroscale element, the presence or absence of regions where structures likely to be detrimental to the integrity of the component would be expected to occur when manufacturing a component according to the design; and
(v) if regions where structures likely to be detrimental to the integrity of the component would be expected to occur are identified, outputting data describing these regions to a redesign process.

32. The method of claim 31, further comprising:
obtaining a second design from the redesign process;
defining within the second design a division of the second design into a plurality of second macroscale elements, where each second macroscale element is larger than the thickness of an individual layer of material in the second design;
for each second macroscale element, defining a second microscale representative volume element, determining second model parameters for the second microscale representative volume element, and upscaling the second microscale representative volume element to provide a set of second model parameters describing the second macro scale element; and
identifying within the second design, using the set of second model parameters for each second macroscale element, the presence or absence of regions where structures likely to be detrimental to the integrity of the component would be expected to occur when manufacturing a component according to the second design.

33. The method of claim 31, further comprising, if regions where structures likely to be detrimental to the integrity of the component would be expected to occur are not identified, outputting the design.

34. The method of claim 31, further comprising using a higher order continuum model for at least one of:
defining within the design a division of the design into a plurality of macroscale elements, where each macroscale element is larger than the thickness of an individual layer of material in the design;
for each macroscale element, defining a microscale representative volume element, determining model parameters for the microscale representative volume element, and upscaling the microscale representative volume element to provide a set of model parameters describing the macroscale element; and
identifying within the design, using the set of model parameters for each macroscale element, the presence or absence of regions where structures likely to be detrimental to the integrity of the component would be expected to occur when manufacturing a component according to the design.

35. The method of claim 34, wherein the higher order continuum model averages internal moments over each relative volume element to determine the model parameters for the microscale representative volume element, thereby providing computational efficiency.

36. The method of claim 34, wherein the higher order continuum model is a Cosserat model.

37. The method of claim 31, further comprising using a finite element method when identifying within the design, using the set of model parameters for each macroscale element, the presence or absence of regions where structures likely to be detrimental to the integrity of the component would be expected to occur when manufacturing a component according to the design.

38. The method of claim 31, wherein a region where structures likely to be detrimental to the integrity of the component would be expected to occur during a debulking step of manufacturing a component according to the design.

39. The method of claim 31, wherein structures likely to be detrimental to the integrity of the component include one or more selected from the group comprising: a wrinkle in one or more layers of pre-impregnated uni-directional material; a structure that exceeds a dimensional envelope for the component; and a structure that does not meet a physical parameters definition for the component.

40. The method of claim 31, further comprising manufacturing the component using pre-impregnated uni-directional or woven material.

41. A method of designing a composite component for manufacture using a pre-impregnated uni-directional or woven material; the method comprising:
(i) creating a design for a composite component comprising multiple layers of pre-impregnated uni-directional or woven material;
(ii) defining within the design a division of the design into a plurality of macroscale elements, where each macroscale element is larger than the thickness of an individual layer of material in the design;
(iii) for each macroscale element, defining a microscale representative volume element, determining model parameters for the microscale representative volume element, and upscaling the microscale representative volume element to provide a set of model parameters describing the macroscale element;
(iv) identifying within the design, using the set of model parameters for each macroscale element, the presence or absence of regions where wrinkling or buckling of one or more of the multiple layers would be expected to occur during a debulking process when manufacturing a component according to the design; and
(v) if regions where structures likely to be detrimental to the integrity of the component would be expected to occur are identified, outputting data describing these regions to a redesign process.

42. A computer, programmed for designing a composite component for manufacture using a pre-impregnated uni-directional or woven material; the computer including programming for:
(i) creating a design for a composite component comprising multiple layers of pre-impregnated uni-directional or woven material;
(ii) defining within the design a division of the design into a plurality of macroscale elements, where each macroscale element is larger than the thickness of an individual layer of material in the design;
(iii) for each macroscale element, defining a microscale representative volume element, determining model parameters for the microscale representative volume element, and upscaling the microscale representative volume element to provide a set of model parameters describing the macro scale element;
(iv) identifying within the design, using the set of model parameters for each macroscale element, the presence or absence of regions where wrinkling or buckling of one or more of the multiple layers would be expected to occur during a debulking process when manufacturing a component according to the design; and
(v) if regions where structures likely to be detrimental to the integrity of the component would be expected to occur are identified, outputting data describing these regions to a redesign process.

43. The computer of claim 42, further comprising programming for:
(i) creating a design for a composite component comprising multiple layers of pre-impregnated uni-directional or woven material;
(ii) defining within the design a division of the design into a plurality of macroscale elements, where each macroscale element is larger than the thickness of an individual layer of material in the design;
(iii) for each macroscale element, defining a microscale representative volume element, determining model parameters for the microscale representative volume element, and upscaling the microscale representative volume element to provide a set of model parameters describing the macro scale element;
(iv) identifying within the design, using the set of model parameters for each macroscale element, the presence or absence of regions where structures likely to be detrimental to the integrity of the component would be expected to occur when manufacturing a component according to the design; and
(v) if regions where structures likely to be detrimental to the integrity of the component would be expected to occur are identified, outputting data describing these regions to a redesign process.

44. The computer of claim 42, further comprising programming for:
obtaining a second design from the redesign process;
defining within the second design a division of the second design into a plurality of second macroscale elements, where each second macroscale element is larger than the thickness of an individual layer of material in the second design;
for each second macroscale element, defining a second microscale representative volume element, determining second model parameters for the second microscale representative volume element, and upscaling the second microscale representative volume element to provide a set of second model parameters describing the second macro scale element; and
identifying within the second design, using the set of second model parameters for each second macroscale element, the presence or absence of regions where structures likely to be detrimental to the integrity of the component would be expected to occur when manufacturing a component according to the second design.

45. The computer of claim 42, further comprising programming for, if regions where structures likely to be detrimental to the integrity of the component would be expected to occur are not identified, outputting the design.

46. The computer of claim 42, further comprising programming for using a higher order continuum model for at least one of:
defining within the design a division of the design into a plurality of macroscale elements, where each macroscale element is larger than the thickness of an individual layer of material in the design;
for each macroscale element, defining a microscale representative volume element, determining model parameters for the microscale representative volume element, and upscaling the microscale representative volume element to provide a set of model parameters describing the macroscale element; and
identifying within the design, using the set of model parameters for each macroscale element, the presence or absence of regions where structures likely to be detrimental to the integrity of the component would be expected to occur when manufacturing a component according to the design.

47. The computer of claim 46, wherein the higher order continuum model averages internal moments over each relative volume element to determine the model parameters for the microscale representative volume element, thereby providing computational efficiency.

48. The computer of claim 46, wherein the higher order continuum model is a Cosserat model.

49. The computer of claim 42, further comprising programming for using a finite element method when identifying within the design, using the set of model parameters for each macroscale element, the presence or absence of regions where structures likely to be detrimental to the integrity of the component would be expected to occur when manufacturing a component according to the design.

50. The computer of claim 42, wherein a region where structures likely to be detrimental to the integrity of the component would be expected to occur during a debulking step of manufacturing a component according to the design.

51. The computer of claim 42, wherein structures likely to be detrimental to the integrity of the component include one or more selected from the group comprising: a wrinkle in one or more layers of pre-impregnated uni-directional material; a structure that exceeds a dimensional envelope for the component; and a structure that does not meet a physical parameters definition for the component.
